(19) United States
(12) Patent Application Publication
(10) Pub. No.: US 2016/0043483 A1
(43) Pub. Date: Feb. 11, 2016

(54) SEQUENCER TERMINAL BLOCK, SEQUENCER, AND SEQUENCER UNIT

(71) Applicants: Akimasa HAMA, Chiyoda-ku, Tokyo (JP); Atsunori AOKI, Chiyoda-ku, Tokyo (JP); Manabu KAWASAKI, Chiyoda-ku, Tokyo (JP)

(72) Inventors: Akimasa HAMA, Tokyo (JP); Atsunori AOKI, Tokyo (JP); Manabu KAWASAKI, Tokyo (JP)

(73) Assignee: Mitsubishi Electric Corporation, Chiyoda-ku, Tokyo (JP)

(21) Appl. No.: 14/766,816

(22) PCT Filed: Mar. 29, 2013
(86) PCT No.: PCT/JP2013/059601

§ 371 Date: Aug. 10, 2015

(51) Int. Cl. H01R 9/24

(52) U.S. Cl. CPC H01R 9/2416

(57) ABSTRACT

To provide a sequencer terminal block having a terminal connection surface on which a plurality of terminal connection portions, to which terminals can be respectively connected, are arrayed. The sequencer terminal block includes a band attachment portion formed to protrude in a first direction parallel to an array direction of the terminal connection portions. The band attachment portion includes two first legs formed to protrude in the first direction, and a first joining portion that joins ends of the first legs to each other. An area surrounded by an attachment-portion forming surface on which the band attachment portion is formed, the first legs, and the first joining portion becomes an insertion hole into which a banding band can be inserted.

### FIELD

The present invention relates to a sequencer terminal block, a sequencer, and a sequencer unit.

### BACKGROUND

Conventionally, in a sequencer unit used for such a system as a factory automation (FA) device, a plurality of sequencers are arrayed and fixed. Such a sequencer includes a terminal block on which a plurality of terminal connection portions, to which wires for input and output of signals are connected, are arrayed. If the wires connected to the terminal connection portions are not held together and are left as they are, the wires may interfere with an adjacent sequencer, thus making attachment and detachment of the sequencer difficult. Furthermore, the visibility of the wiring state is likely to decrease, thereby delaying detection of dropout or the like in the wiring and making it difficult to prevent a ground fault or the like.

Therefore, the wires connected to the terminal connection portions are generally banded and held together with a banding band. To further prevent the wires from spreading apart, the banding band for holding the wires together is fixed. For example, in Patent Literature 1, a band attachment portion for fixing a banding band to a terminal block is provided.

### CITATION LIST

### Patent Literature

Patent Literature 1: Japanese Utility Model Application Publication No. S61-63776

### SUMMARY

### Technical Problem

However, according to the conventional technique described above, the band attachment portion is provided at a position where the band attachment portion overlaps with a route for drawing around the wires, thus reducing the wiring space. Accordingly, the band attachment portion may disturb wiring work and the workability may be deteriorated.

The present invention has been achieved in view of the above problems, and an object of the present invention is to provide a sequencer terminal block having a band attachment portion that is less likely to interfere with wiring.

### Solution to Problem

According to an aspect of the present invention in order to solve the problems and achieve the object, there is provided a sequencer terminal block having a terminal connection surface on which a plurality of terminal connection portions are arrayed, to each of which a terminal can be connected, the sequencer terminal block including a band attachment portion formed to protrude in a first direction parallel to an array direction of the terminal connection portions, wherein the band attachment portion includes two first legs formed to protrude in the first direction, and a first joining portion that joins ends of the two first legs to each other, and an area surrounded by an attachment-portion forming surface on which the band attachment portion is formed, the first legs, and the first joining portion corresponds to an insertion hole into which a banding band can be inserted.

### Advantageous Effects of Invention

According to the present invention, the sequencer terminal block having the band attachment portion that is less likely to interfere with wiring can be provided.

### BRIEF DESCRIPTION OF DRAWINGS

FIG. 1 is a front view illustrating a schematic configuration of a sequencer unit according to a first embodiment of the present invention.

FIG. 2 is a bottom view of the sequencer unit.

FIG. 3 is a perspective view illustrating a schematic configuration of a sequencer including a sequencer terminal block.

FIG. 4 is a diagram illustrating a schematic configuration of the sequencer terminal block and is a perspective view of the sequencer terminal block as viewed from a front side.

FIG. 5 is a partially enlarged view illustrating a part A illustrated in FIG. 4.

FIG. 6 is a right side view of a band attachment portion.

FIG. 7 is a sectional view taken in the direction of arrows B-B illustrated in FIG. 6.

FIG. 8 is a diagram schematically illustrating a state where a banding band is attached to the band attachment portion.

FIG. 9 is a diagram schematically illustrating a state where wires are held together by the banding band.

FIG. 10-1 is a diagram illustrating a procedure for surface texturing around the band attachment portion.

FIG. 10-2 is a diagram illustrating a procedure for surface texturing around the band attachment portion.

FIG. 10-3 is a diagram illustrating a procedure for surface texturing around the band attachment portion.

FIG. 11-1 is a diagram illustrating a procedure for surface texturing around the band attachment portion illustrated as a comparative example.

FIG. 11-2 is a diagram illustrating a procedure for surface texturing around the band attachment portion illustrated as the comparative example.

FIG. 11-3 is a diagram illustrating a procedure for surface texturing around the band attachment portion illustrated as the comparative example.

FIG. 12 is a partially-enlarged perspective view of the band attachment portion illustrated as another comparative example.

FIG. 13 is a partially-enlarged perspective view illustrating a band attachment portion of a sequencer terminal block according to a second embodiment of the present invention and is a diagram illustrating a state where a banding band is attached to the band attachment portion.

### DESCRIPTION OF EMBODIMENTS

Exemplary embodiments of a sequencer terminal block, a sequencer, and a sequencer unit according to the present invention will be explained below in detail with reference to the accompanying drawings. The present invention is not limited to the embodiments.

### First Embodiment

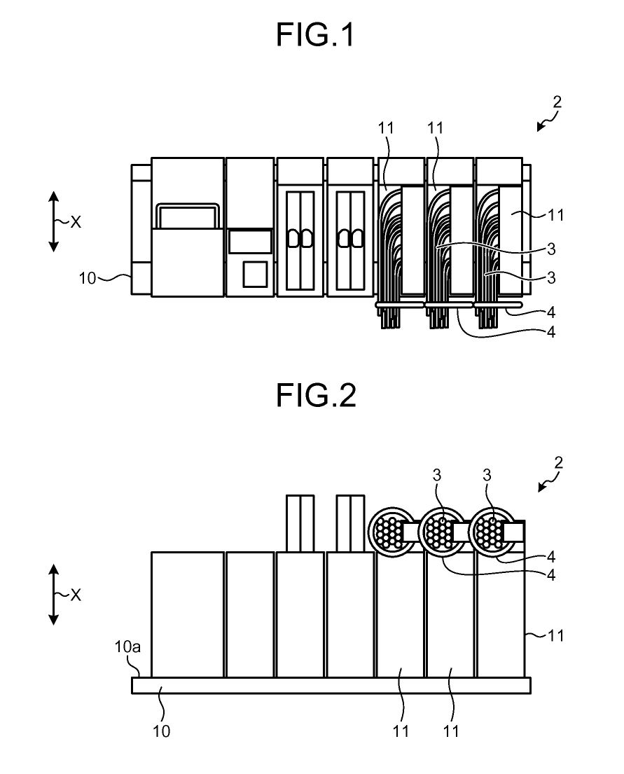

FIG. 1 is a front view illustrating a schematic configuration of a sequencer unit according to a first embodiment of the present invention. FIG. 2 is a bottom view of the sequencer unit. A sequencer unit 2 includes a base 10 and a plurality of sequencers 11. The sequencers 11 are arrayed and fixed to the base 10.

On surfaces of the base 10 and the sequencers 11 facing each other, connectors (not illustrated) are provided for fitting the base 10 and the sequencers 11. The sequencers 11 are electrically connected to each other via the connectors through which transmission and reception of information and transmission and reception of power are performed.

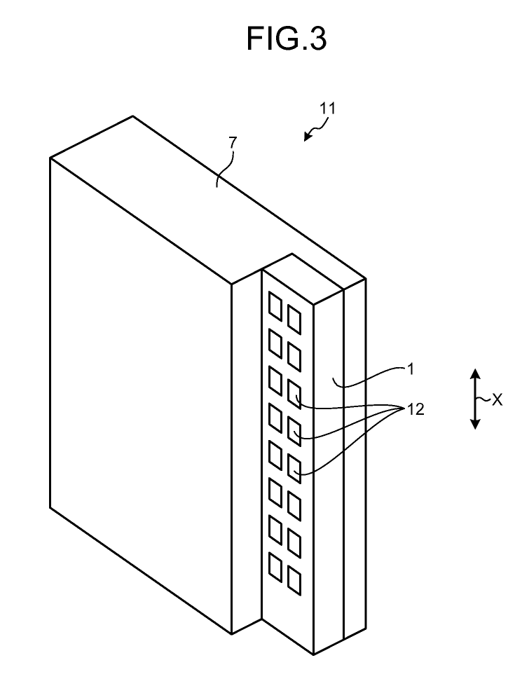

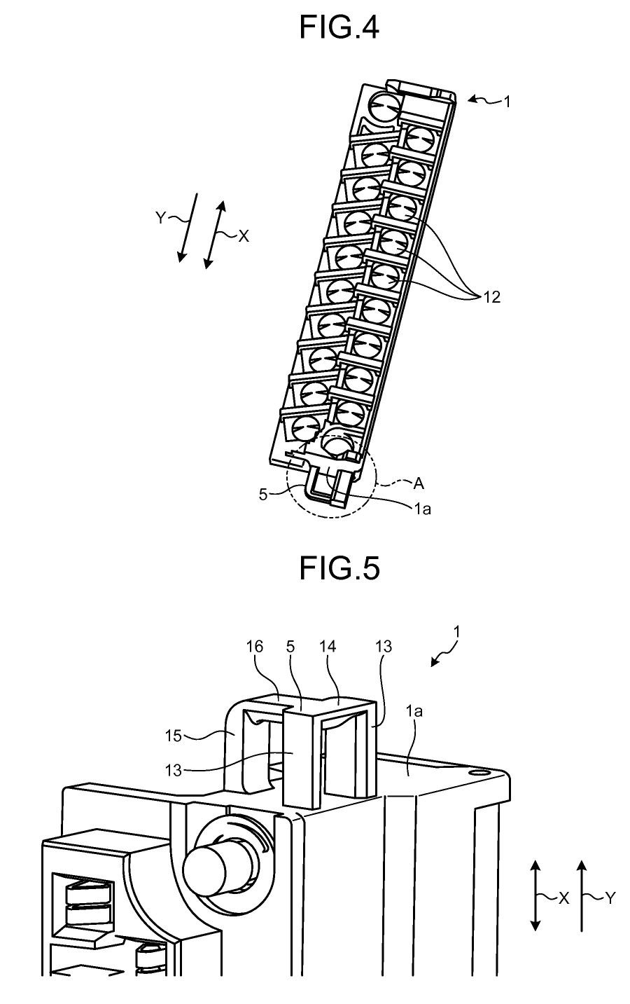

FIG. 3 is a perspective view illustrating a schematic configuration of the sequencer including a sequencer terminal block. FIG. 4 is a diagram illustrating a schematic configuration of the sequencer terminal block and is a perspective view of the sequencer terminal block as viewed from the front side. As illustrated in FIG. 3, the sequencer 11 has a shape close to a cuboid as a whole, and includes a sequencer terminal block 1 on the front side of a body portion 7.

On the sequencer terminal block 1, a plurality of terminal connection portions 12 capable of connecting wires are arrayed in a direction indicated by an arrow X. The direction of the arrow X is perpendicular to an array direction of the sequencers 11 and parallel to a sequencer attachment surface 10a of the base 10. For example, as illustrated in FIG. 4, each of the terminal connection portions 12 is configured to fix a terminal (not illustrated) provided at an end of the wire with a screw.

FIG. 5 is a partially enlarged view illustrating a part A illustrated in FIG. 4. A band attachment portion 5 is provided on one of the surfaces of the sequencer terminal block 1, which corresponds to a bottom surface (an attachment-portion forming surface 1a) of the sequencer 11 in a state of being attached to the sequencer 11. The band attachment portion 5 is provided to protrude in a direction indicated by an arrow Y (first direction). The direction of the arrow Y is parallel to the array direction of the terminal connection portions 12 (the direction indicated by the arrow X) with respect to the attachment-portion forming surface 1a. Because this structure is formed in a housing of the terminal block body, the structure does not adversely affect the wiring performance.

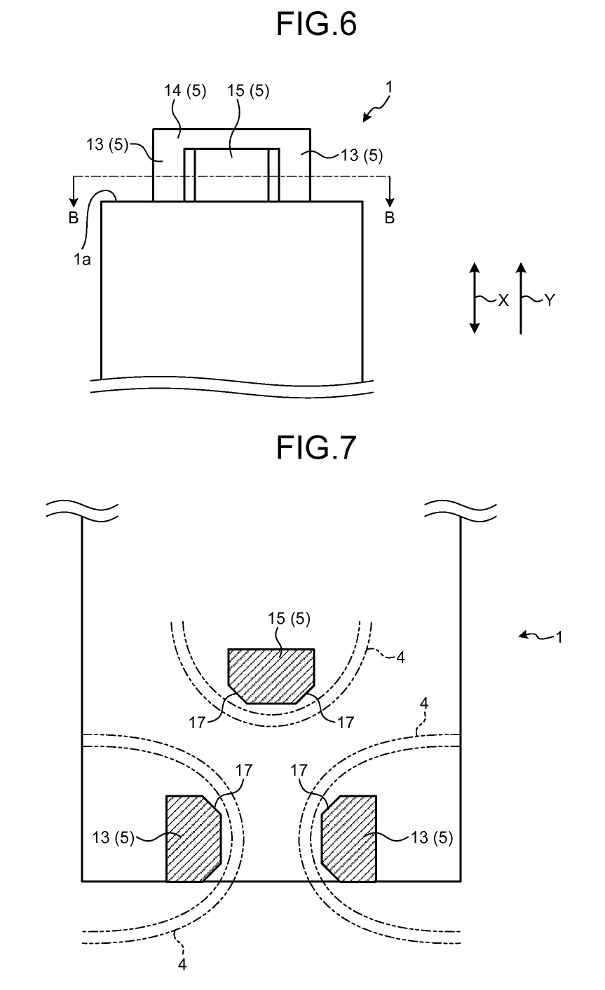

FIG. 6 is a right side view of the band attachment portion. FIG. 7 is a sectional view taken in a direction of arrows B-B illustrated in FIG. 6. The band attachment portion 5 includes first legs 13, a first joining portion 14, a second leg 15, and a second joining portion 16.

The number of the first legs 13 is two and the first legs 13 are formed to protrude from the attachment-portion forming surface 1a in the direction indicated by the arrow Y. As illustrated in FIG. 7, the two first legs 13 are formed at an edge of the attachment-portion forming surface 1a. The first joining portion 14 joins the ends of the first legs 13 to each other. Accordingly, the band attachment portion 5 has a ring shape, so that an area surrounded by the attachment-portion forming surface 1a, the first legs 13, and the first joining portion 14 corresponds to an insertion hole into which a banding band 4 can be inserted.

The second leg 15 is formed to protrude from the attachment-portion forming surface 1a in the direction indicated by the arrow Y. The second joining portion 16 joins an end of the second leg 15 and a middle part of the first joining portion 14. Accordingly, a combination of the first joining portion 14 and the second joining portion 16 has a T shape as viewed in a plan view. An area surrounded by the attachment-portion forming surface 1a, the first legs 13, the first joining portion 14, the second joining portion 16, and the second leg 15 also corresponds to an insertion hole into which the banding band 4 can be inserted. As a result, as illustrated in FIG. 7, three routes into which the banding band 4 can be inserted are formed.

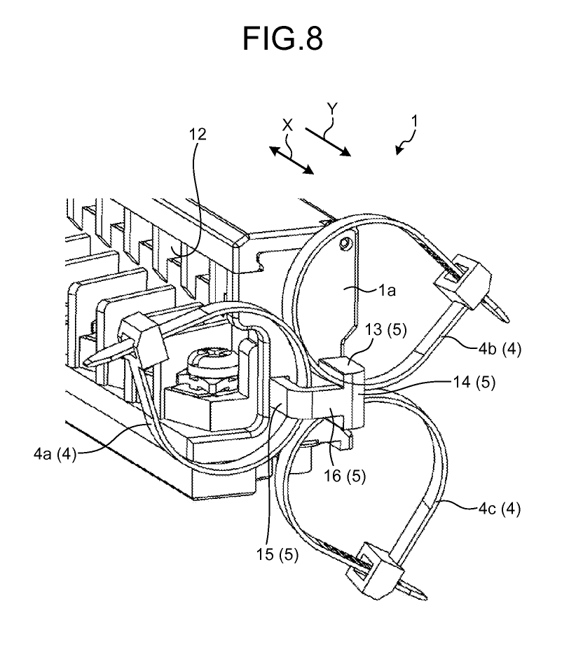

FIG. 8 is a diagram schematically illustrating a state where the banding bands 4 are attached to the band attachment portion 5. As illustrated in FIG. 8, the three routes into each of which the banding band 4 can be inserted are formed, so that a plurality of the banding bands 4 can be attached to the single band attachment portion 5.

As illustrated in FIG. 7, chamfering process is done for corners 17 of the first legs 13, the first joining portion 14, the second leg 15, and the second joining portion 16, facing the inside of an area surrounded by these portions, that is, the corners 17 facing the insertion holes.

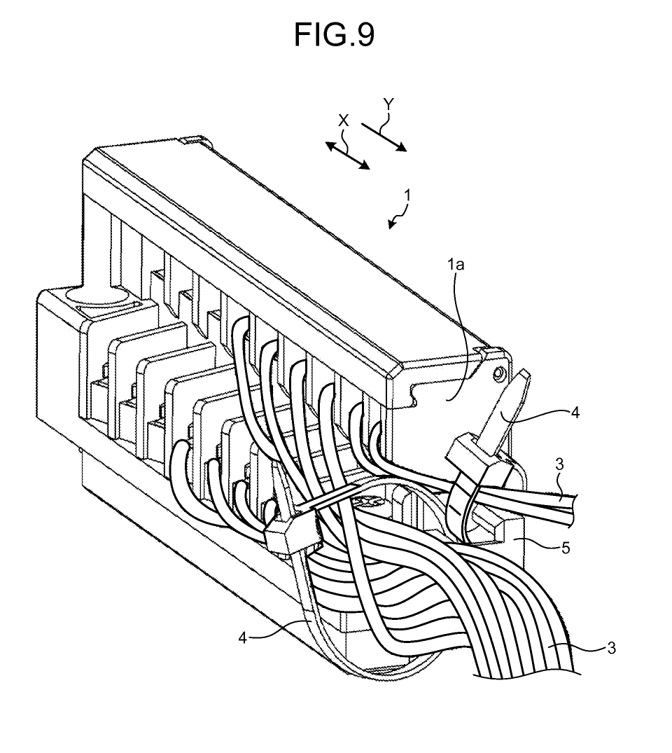

FIG. 9 is a diagram schematically illustrating a state where wires 3 are held together with the banding bands 4. As illustrated in FIG. 9, the banding bands 4 are used for banding a plurality of wires 3 connected to the terminal connection portions 12 together. The banding bands 4 are fastened to the band attachment portion 5 at the time of banding the wires 3 together. The wires 3 connected to the terminal connection portions 12 pass on the surface where the terminal connection portions 12 are provided and are drawn around toward the bottom surface side of the sequencer 11 (see also FIGS. 1 and 2).

According to the sequencer terminal block 1, the sequencer 11, and the sequencer unit 2 described above, the band attachment portion 5 is formed to protrude toward the direction indicated by the arrow Y parallel to the array direction of the terminal connection portions 12 on the sequencer terminal block 1. Therefore, as illustrated in FIG. 9, the band attachment portion 5 is provided at a position away from wiring routes of the wires 3 passing on the surface where the terminal connection portions 12 are provided. Accordingly, the band attachment portion 5 is less likely to interfere with the wiring work, and deterioration of workability can be suppressed.

By combining the wires 3 with the banding bands 4 so as to fix the wires 3 to the sequencer terminal block 1, the appearance of the system is improved and the wires 3 are less likely to interfere with an adjacent sequencer 11, thereby facilitating attachment/detachment of the sequencer 11.

Furthermore, the wires 3 and the sequencer terminal block 1 are combined. In a case that the sequencer terminal block 1 is detached from the body portion 7 of the sequencer 11, the detached sequencer terminal block 1 can be attached to another body portion 7 of another sequencer 11 and used as it is.

Tensile strength against pulling of the wires 3 is improved. Even if the wires 3 drop out, the possibility of a grounding fault due to the dropping can be decreased because the wires 3 are combined with the banding bands 4.

As illustrated in FIG. 8, because the plurality of the banding bands 4 can be fixed to the band attachment portion 5, the wires 3 can be divided into several groups and held together. Also in this case, because the banding bands 4 are less likely to interfere with each other, the workability can be improved. Because the wires can be divided into several groups and held together, wires that are hard to hold together, such as signal wires and power wires, can be divided into groups and held together.

By selecting the insertion hole to be used, a fixing method can be selected according to the purpose. For example, when it is desired to draw out wires downward and fix the wires, the insertion hole can be selected as in the case of a banding band 4a illustrated in FIG. 8. When it is desired to draw out the wires to the front and fix crossover wires to the terminal block of an adjacent sequencer 11, the insertion hole can be selected as in the case of a banding band 4b illustrated in FIG. 8. Further, when it is desired to draw wires toward the base 10 to make it hard to see and fix the wires with an improved appearance, the insertion hole can be selected as in the case of a banding band 4c illustrated in FIG. 8. In this way, the banding band 4 can be fixed in an appropriate orientation for the wiring route by selecting an insertion hole into which the banding band 4 is inserted even if the plurality of the banding bands 4 are not necessarily used.

As illustrated in FIG. 7, the corners 17 facing the insertion holes are chamfered. When the banding band 4 is inserted into the insertion hole, an end of the banding band 4 is easily guided into the insertion hole smoothly by the chamfered corners 17. Therefore, the banding band 4 is easily inserted into the insertion hole, and attachment work of the banding band 4 can be facilitated. Accordingly, the workability in a dark place can be also improved.

The corners 17 are portions with which the banding band 4 comes in contact when the banding band 4 is fastened. Therefore, because the corners 17 are chamfered, a local load is less likely to be applied to the banding band 4. Accordingly, the banding band 4 is less likely to be damaged.

Surface texturing may be performed on the surface of the sequencer terminal block 1. According to the band attachment portion 5 of the sequencer terminal block 1 of the first embodiment, the operability of surface texturing can be improved and the appearance of the sequencer terminal block 1 after having been subjected to the surface texturing can be improved. This point is described below in detail with reference to the drawings.

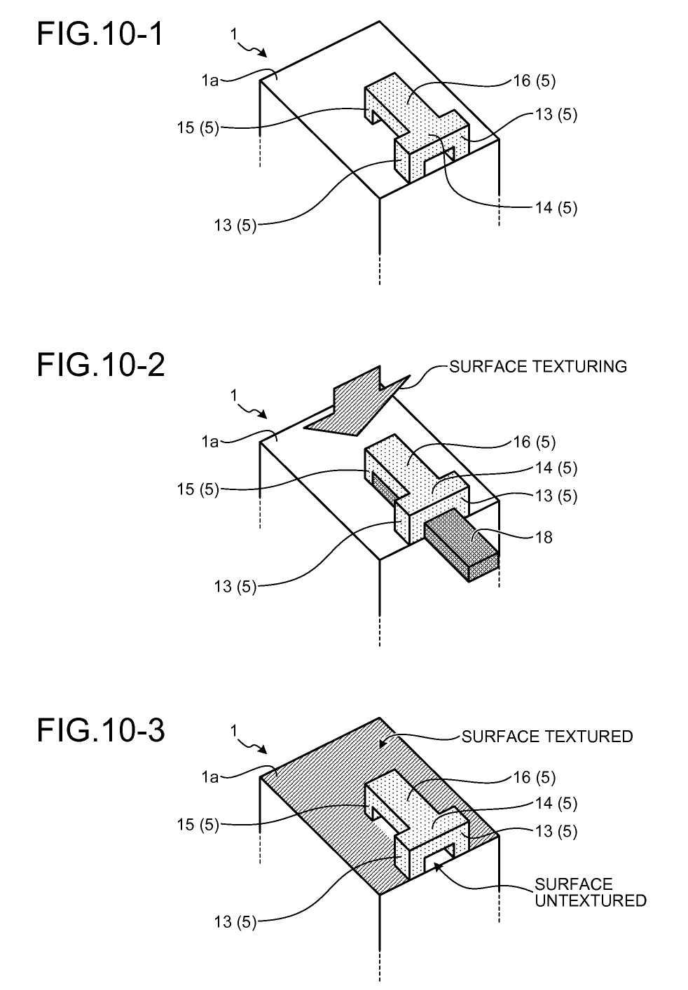

A procedure for surface texturing is described first. FIGS. 10-1 to 10-3 are diagrams illustrating a procedure for surface texturing around the band attachment portion 5. FIG. 10-1 illustrates a vicinity of the band attachment portion 5 in a state where the surface texturing is not performed. As illustrated in FIG. 10-2, in a state where a mold slide core 18 is inserted as a jig into the insertion hole of the band attachment portion 5, the surface texturing is performed onto the surface of the sequencer terminal block 1 including the attachment-portion forming surface 1a.

At this time, the surface texturing is not performed on an area covered with the mold slide core 18, which is provided as an area not subjected to the surface texturing. However, as illustrated in FIG. 10-3, because the first legs 13 of the band attachment portion 5 are formed at the edge of the attachment-portion forming surface 1a, most of the area not subjected to the surface texturing is hidden by the band attachment portion 5. Therefore, the area not subjected to the surface texturing is hardly viewed, thereby improving the appearance of the sequencer terminal block 1.

The width of the area not subjected to the surface texturing depends on the width of the mold slide core 18. Because the mold slide core 18 is inserted from the insertion hole surrounded by the attachment-portion forming surface 1a, the first legs 13, and the first joining portion 13, the width of the area not subjected to the surface texturing does not become larger than the width of the insertion hole.

Accordingly, by making the width of the second joining portion 16 to be at least larger than the width of the insertion hole surrounded by the attachment-portion forming surface 1a, the first legs 13, and the first joining portion 14, the area not subjected to the surface texturing can be reliably hidden by the undersides of the first joining portion 14 and the second joining portion 16 as viewed in a plan view. Further, by making the width of the second joining portion 16 larger, the area not subjected to the surface texturing can be made less visible.

Because the second leg 15 is provided in the insertion direction of the mold slide core 18, the mold slide core 18 can be inserted until striking against the second leg 15. Therefore, fine adjustment or the like of the insertion amount is not required at the time of inserting the mold slide core 18, and the operability can be improved.

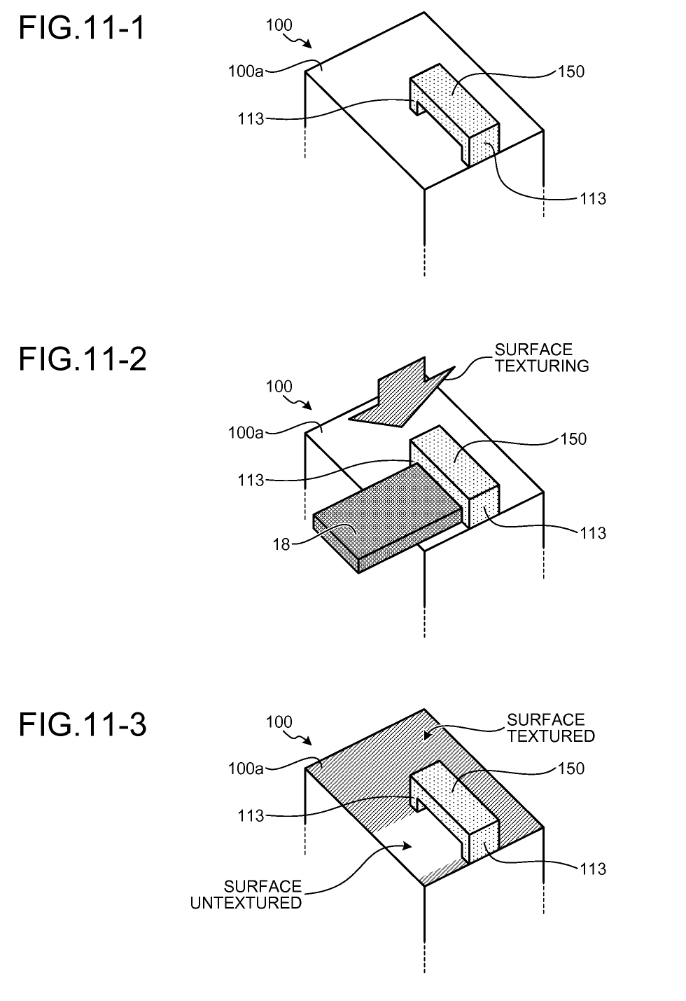

A procedure for surface texturing to a sequencer terminal block 100 including a band attachment portion 150 illustrated is now described as a comparative example. FIGS. 11-1 to 11-3 are diagrams illustrating a procedure for surface texturing around a band attachment portion illustrated as the comparative example.

In the band attachment portion 150 illustrated as the comparative example, one of legs 113 is formed at a position away from an edge of an attachment-portion forming surface 100a. Therefore, due to the mold slide core 18a for covering, a part of an area not subjected to the surface texturing is not hidden by the band attachment portion 150 and exposed, thus deteriorating the appearance of the sequencer terminal block 100. In contrast thereto, according to the present embodiment, as described above, because the area not subjected to the surface texturing is less visible, the appearance can be improved.

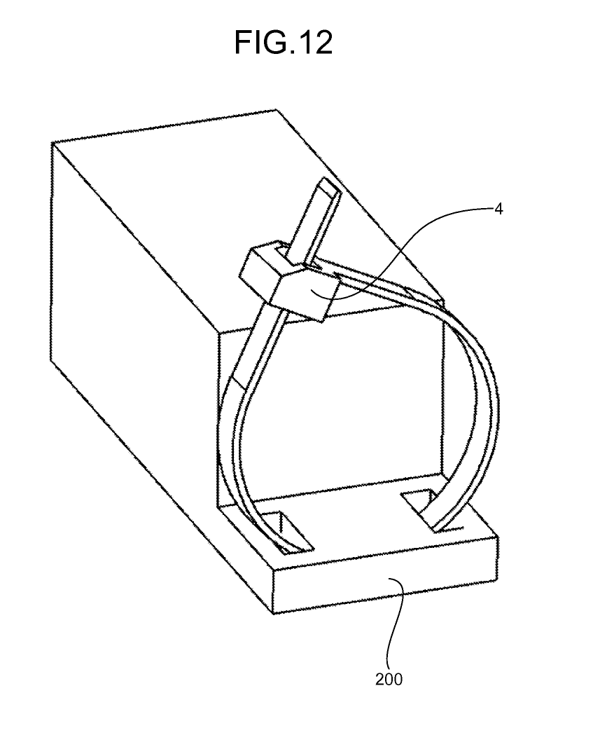

FIG. 12 is a partially-enlarged perspective view of a band attachment portion illustrated as another comparative example. In a band attachment portion 200 illustrated as another comparative example, two working steps are required at the time of providing one banding band 4, one is to insert an end of the banding band 4 into one of insertion holes and the other is draw out the end of the banding band 4 from the other insertion hole. Therefore, an increase in the labor hours and deterioration of the workability at the time of providing the banding band 4 is likely to be a problem. In contrast thereto, according to the present embodiment, because the banding band 4 can be provided only by inserting an end of the banding band 4 into the insertion hole once, an increase in the labor hours can be suppressed and the workability can be improved.

### Second Embodiment

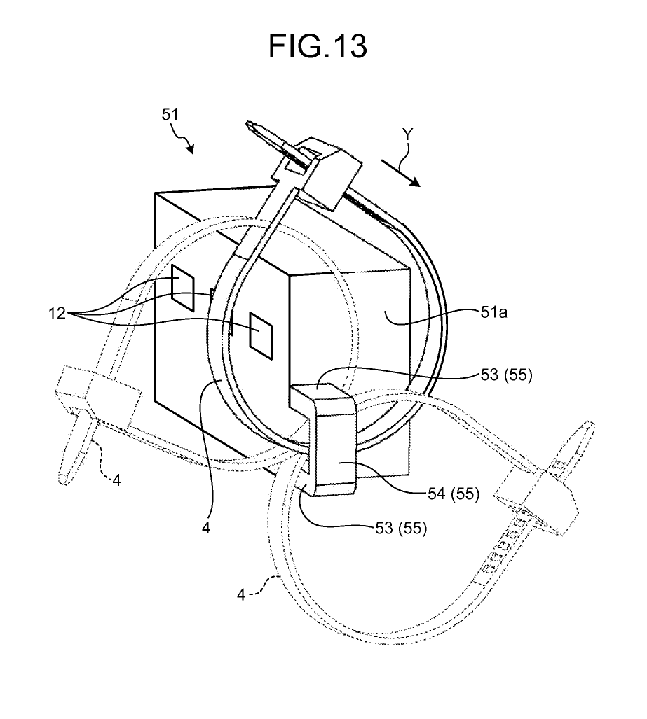

FIG. 13 is a partially-enlarged perspective view illustrating a band attachment portion of a sequencer terminal block according to a second embodiment of the present invention and is a diagram illustrating a state where a banding band is attached to the band attachment portion. Constituent elements identical to those in the first embodiment described above are denoted by like reference signs, and detailed descriptions thereof are omitted.

In a band attachment portion 55 of a sequencer terminal block 51 according to the second embodiment, the second leg 15 and the second joining portion 16 (see also FIG. 5, and the like) described in the above embodiment are not provided. Meanwhile, because two first legs 53 are formed at an edge of an attachment-portion forming surface 51a as in the first embodiment, an area not subjected to the surface texturing can be hidden by the band attachment portion 55 including a first joining portion 54. However, because the mold slide core 18 (see also FIG. 10-2) cannot be struck against the second leg 15, the operability slightly decreases.

As in the first embodiment, the band attachment portion 55 is formed to protrude in the direction indicated by the arrow Y parallel to the array direction of the terminal connection portions 12. The band attachment portion 55 is provided at a position away from the wiring route of the wires 3 connected to the terminal connection portions 12. Accordingly, the band attachment portion 55 is less likely to interfere with the wiring work, and deterioration of the workability can be suppressed.

The banding band 4 can be provided only by inserting an end of the banding band 4 into the insertion hole once. Therefore, unlike the band attachment portion 200 illustrated in FIG. 12, after inserting the banding band 4 into one of insertion holes, it is not required to draw out the banding band 4 with the position thereof matched with the other insertion hole. Accordingly, an increase in the labor hours can be suppressed and the workability can be improved.

### INDUSTRIAL APPLICABILITY

As described above, the sequencer terminal block according to the present invention is useful for a sequencer terminal block where a plurality of wires are connected to terminal connection portions.

### REFERENCE SIGNS LIST

1 sequencer terminal block, 1a attachment-portion forming surface, 2 sequencer unit, 3 wire, 44a, 4b, 4c banding band, 5 band attachment portion, 7 body portion, 10 base, 10a sequencer attachment surface, 11 sequencer, 12 terminal connection portion, 13 first leg, first joining portion, 15 second leg, 16 second joining portion, 17 corner, 18 mold slide core, 51 sequencer terminal block, 51a attachment-portion forming surface, 53 first leg, 54 first joining portion, 55 band attachment portion, 100 sequencer terminal block, 113 leg, 150, 200 band attachment portion.

1. A sequencer terminal block having a terminal connection surface on which a plurality of terminal connection portions are arrayed, to each of which a terminal can be connected, the sequencer terminal block comprising
a band attachment portion formed to protrude in a first direction parallel to an array direction of the terminal connection portions, wherein
the band attachment portion includes two first legs formed to protrude in the first direction, and a first joining portion that joins ends of the two first legs to each other, and
an area surrounded by an attachment-portion forming surface on which the band attachment portion is formed, the first legs, and the first joining portion corresponds to an insertion hole into which a banding band can be inserted, and
a gap between the attachment-portion forming surface and the first joining portion is larger than a width of the banding band.

2. The sequencer terminal block according to claim 1, wherein
the band attachment portion further includes a second leg formed to protrude in the first direction from the attachment-portion forming surface, and a second joining portion that joins an end of the second leg with a middle part of the first joining portion, and
a combination of the first joining portion and the second joining portion form a T-shape.

3. The sequencer terminal block according to claim 2, wherein corners of the first legs, the first joining portion, the second leg, and the second joining portion, facing an inside of an area surrounded by these portions are chamfered.

4. The sequencer terminal block according to claim 1, wherein the first legs are formed to protrude at an edge of the attachment-portion forming surface.

5. A sequencer comprising:
the sequencer terminal block according to claim 1; and
a body portion to which the sequencer terminal block is attached.

6. A sequencer unit comprising:
a plurality of the sequencers according to claim 5; and
a base on which the sequencers are arrayed and fixed.
